(19) United States
(12) Patent Application Publication
(10) Pub. No.: US 2017/0093648 A1
(43) Pub. Date: Mar. 30, 2017

(54) SYSTEM AND METHOD FOR ASSESSING STREAMING VIDEO QUALITY OF EXPERIENCE IN THE PRESENCE OF END-TO-END ENCRYPTION

(71) Applicant: Wi-LAN Labs, Inc., Carlsbad, CA (US)

(72) Inventors: Ahmed ElArabawy, San Diego, CA (US); Yiliang Bao, San Diego, CA (US); David Gell, San Diego, CA (US); Kenneth Stanwood, Vista, CA (US)

(21) Appl. No.: 15/277,669

(22) Filed: Sep. 27, 2016

Related U.S. Application Data
(60) Provisional application No. 62/289,127, filed on Jan. 29, 2016.
(60) Provisional application No. 62/233,860, filed on Sep. 28, 2015.

(51) Int. Cl. H04L 12/24; H04L 12/26; G06N 3/08; H04L 29/06

(52) U.S. Cl. CPC H04L 41/5067; H04L 65/4069; H04L 43/12; G06N 3/08; H04L 63/0457

(57) ABSTRACT

Systems and method can determine a quality of experience metric associated with a video stream being played at a terminal node when packets conveying the video stream are encrypted. Packets associated with a video stream are received at the terminal from a video server. A quality assessment module derives packet information from the packets. The packet information can include identification information and packet statistics. Video stream features are extracted based on the packet information. An occupancy level of a video playback buffer in the terminal node is estimated from the video stream features. The quality assessment module generates the quality of experience metric based at least in part on the estimated occupancy level of the video playback buffer in the terminal node. The quality assessment module can use machine learning processes, for example, neural networks.

### CROSS-REFERENCE TO RELATED APPLICATIONS

This application claims the benefit of U.S. provisional application Ser. No. 62/233,860, filed Sep. 28, 2015, and U.S. provisional application Ser. No. 62/289,127, filed Jan. 29, 2016, all of which are hereby incorporated by reference.

### BACKGROUND

Video is an ever increasing percentage of network traffic both in wired and wireless networks. Delivery of packets containing video in a manner such that the user's quality of experience is maintained is essential to keeping customers satisfied. Customer satisfaction can impact subscription rates for both the video service and the network service. Historically, networks have derived metrics that indicate quality of service (QoS) without further derivation of metrics regarding quality of experience (QoE). It is advantageous to measure and monitor the video QoE experienced by users of streaming video. U.S. Pat. No. 9,380,091 and U.S. Patent Publication No. 2015/021539, both entitled “Systems and Methods for Using Client-Side Video Buffer Occupancy for Enhanced Quality of Experience in a Communication Network,” describe methods for deriving metrics indicating video QoE including methods for use in the presence of digital rights management (DRM).

Video services are, however, increasingly encrypted end-to-end, for instance using the transport layer security (TLS) protocol. This encryption may impact the availability of information in prior methods. Hence it is advantageous to develop methods to derive metrics indicating video QoE even when a video stream is encrypted end-to-end.

### SUMMARY

In one aspect, a method is provided for determining a quality of experience metric associated with a video stream being played at a terminal node. The method includes: receiving packets associated with the video stream, the packets being transmitted from a video server to the terminal node, at least some of the packets being encrypted; deriving packet information from the packets, the packet information including identification information and packet statistics; extracting video stream features based on the packet information; estimating an occupancy level of a video playback buffer associated with the video stream in the terminal node, the occupancy level being estimated using the video stream features; and generating the quality of experience metric based at least in part on the estimated occupancy level of the video playback buffer in the terminal node.

In another aspect, a network device is provided that includes: a network interface for receiving packets associated with a video stream, the packets transmitted from a video server to a terminal node, at least some of the packets being encrypted; a memory configured to store executable instructions; and a processor coupled to the network interface and the memory and configured to derive packet information from the packets, the packet information including identification information and packet statistics, extract video stream features based on the packet information, estimate an occupancy level of a video playback buffer associated with the video stream in the terminal node using the video stream features, and generate a quality of experience metric based at least in part on the estimated occupancy level of the video playback buffer in the terminal node.

In another aspect, a non-transitory computer readable medium is provided. The medium stores instructions that when executed perform steps for determining a quality of experience metric associated with a video stream being played at a terminal node. The steps include: deriving packet information from packets associated with a video stream, the packets transmitted from a video server to a terminal node, at least some of the packets being encrypted, the packet information including identification information and packet statistics; extracting video stream features based on the packet information; estimating an occupancy level of a video playback buffer associated with the video stream in the terminal node using the video stream features; and generating the quality of experience metric based at least in part on the estimated occupancy level of the video playback buffer in the terminal node.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of a communication system in accordance with aspects of the invention;

FIG. 2 is a block diagram of a network device in accordance with aspects of the invention;

FIG. 3 is a block diagram of a quality assessment module in accordance with aspects of the invention;

FIG. 4 is a flowchart of a process for initialization of a quality assessment module in accordance with aspects of the invention;

FIG. 5 is a flowchart of a quality assessment process in accordance with aspects of the invention;

FIG. 6 illustrates relationships between sessions and connections;

FIG. 7 is a block diagram of a system for generating configuration data for quality assessment in accordance with aspects of the invention;

FIG. 8 is a flowchart of a process for creating a classification model configuration and a buffer model configuration in accordance with aspects of the invention;

FIG. 9 illustrates elements of an exemplary video transaction in accordance with aspects of the invention; and

FIG. 10 illustrates an exemplary sample period in accordance with aspects of the invention.

### DETAILED DESCRIPTION

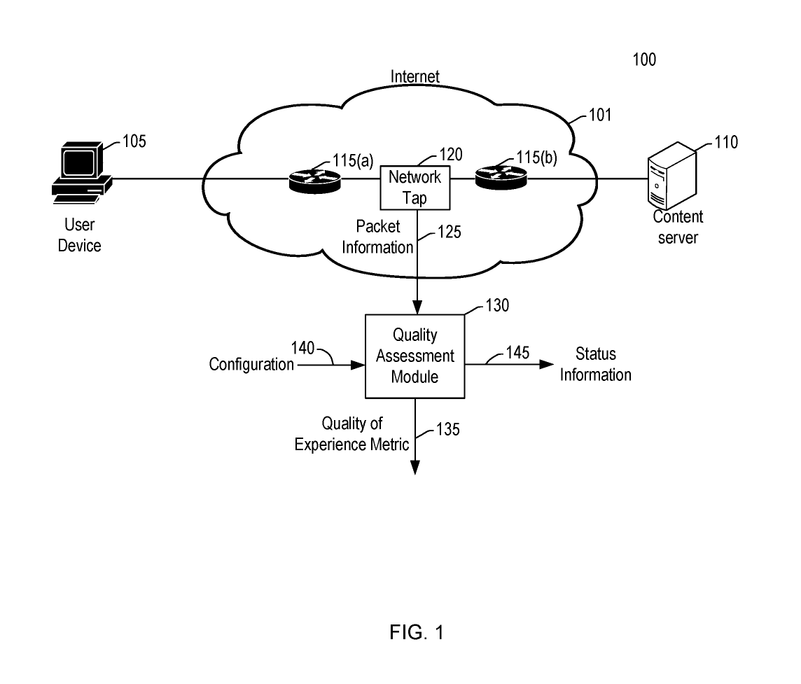

FIG. 1 is a block diagram of a system 100. A content server 110 provides video content that may be viewed by a user on a user device 105. The content server 110, for example, may be a single server, a number of servers that provide different portions of a video stream, a content delivery network (CDN), data caches, or a combination thereof. The user device 105 may be of various forms, such as a smartphone, tablet, laptop, smart television, television connected to a streaming video device, or a desktop computer.

Video data may be streamed from the content server 110 to the user device 105 via communication links including links in the Internet 101. The user device 105 and the content server 110 may connect to the Internet 101 via an access network such as provided by a mobile network operator, cable operator, digital subscriber (DSL) operator, or other Internet service provider (ISP). An enterprise network or intranet may also connect the content server 110 and the user device 105. Connectivity through the Internet 101 may pass through one or more routers 115. A network tap 120 derives packet information 125 from packets flowing between the content server 110 and the user device 105. The network tap 120 is shown as a separate device in the system 100 of FIG. 1. The network tap 120 may be a network tap device such as the Datacom FTP-1516 40G Multi-Wavelength Fiber Tap. Alternatively, the network tap 120 may be a network packet broker, may be incorporated as functionality in a router 115, or may take other forms. The network tap 120 is shown in the Internet 101 as an example. The network tap 120 may be placed in any of various locations between the content server 110 and the user device 105, such as in an access network or an enterprise network. Network taps may be present in multiple locations, for example, for identification of network portions experiencing performance issues.

The packet information 125 is passed from the network tap 120 to a quality assessment module 130. The quality assessment module 130 may be one or more devices that are separate from the network tap 120. Alternatively, the quality assessment module 130 may be in the same device as the network tap 120. The packet information 125 may include be a copy of some or all of the packets, in whole or in part, flowing through the network tap 120. The packet information 125 may include identification information that is not obscured by end-to-end encryption such as source and destination Internet protocol (IP) addresses, port numbers, protocol identifiers, user IDs, server IDs, and network IDs. The packet information 125 may include packet statistics such as packet sizes, packet counts, packet arrival times, packet inter-arrival times, and direction of packet flow. The packet information 125 may include information about connections, such as number of current connections, packets per connection (for current period and cumulative), bytes per connection (for current period and cumulative), minimum/maximum/average packet size, connection start time, connection end time, and connection duration. The packet information 125 may include association between identification information and packet statistics. The packet information 125 may be based in whole or in part on standards-based or vendor specific reporting protocols, such as Internet Protocol Flow Information Export (IPFIX) or Netfilter.

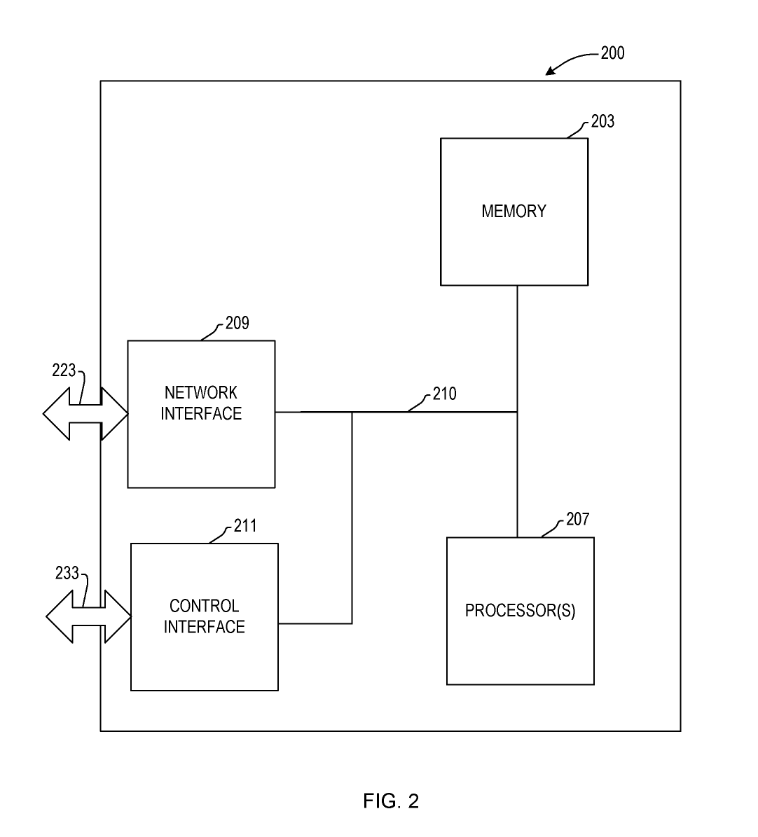

As will be described in more detail with respect to FIGS. 2, 4, and 5, the quality assessment module 130 accepts the packet information 125 and, using configuration 140, transforms the packet information 125 into a quality of experience metric 135, which may include multiple values and which may also be referred to as quality information. The configuration 140 may include information such as mapping of identification information to video services, such as Netflix or YouTube. In an embodiment, the configuration 140 contains neural network weights allowing a neural network to be configured to transform the packet information 125 into the quality of experience metric 135.

The quality of experience metric 135 may include information such as video mean opinion score (VMOS), duration of a video stream, initial buffering delay, and re-buffering stall statistics such as time, duration, frequency, and time between re-buffering stalls. The quality of experience metric 135 may provide information for individual video sessions or may be combined for groups of video sessions. The quality of experience metric 135 may be reported periodically or may be reported for a video session as a whole. The quality of experience metric 135 may include identification information associated with a video stream. The quality of experience metric 135 may include a confidence level or error interval associated with one or more elements of the quality of experience metric 135 (e.g., VMOS, initial buffer delay, rebuffering statistics).

The quality assessment module 130 may also produce status information 145 relating to performance of the quality assessment module 130. For example, the status information 145 may include information describing the statistical confidence of the quality of experience metric 135, which may be used, for example, to alert a system administrator when the quality assessment module 130 is performing poorly. Status information 145 may include system resource usage information which may report memory, CPU, and network utilization of the quality assessment module 130. Such information may be used, for example, by a system administrator to adjust packet information sampling/filtering rates or the amount of hardware resources being allocated to the quality assessment module 130.

FIG. 2 is a block diagram of a network device 200. The quality assessment module 130 may be implemented on the network device 200. The network device 200 contains a memory 203, a processor 207, a network interface 209, and a control interface 211 communicatively coupled by one or more buses or communication paths 210.

The memory 203 may be any one or a combination of memory devices. The memory 203 may contain executable instructions, the configuration 140, the packet information 125 to be transformed into the quality of experience metric 135, and outputs such as the quality of experience metric 135 and the status information 145. The memory 203 may include a non-transitory computer readable medium that may store instructions that when executed perform various processes.

The processor 207 may be any one or a combination of processing devices. The processor 207 may execute instructions retrieved from the memory 203 and perform transformation of the packet information 125 into the quality of experience metric 135. The processor 207 may configure the network device 200 and transformation algorithms using the configuration 140. The processor 207 may generate the status information 145.

The network interface 209 contains hardware and logic to interface to a network for establishment of communication paths 223 to receive the packet information 125 and transfer the information to the memory 203 and the processor 207. For instance, the network interface 209 may contain hardware and logic implementing a gigabit Ethernet port. The network interface 209 may also use the communication paths 223 to report the quality of experience metric 135 to an entity connected to the network, such as a network management reporting tool.

The control interface 211 contains hardware and logic to interface to a network for establishment of communication paths 233 to receive the configuration 140 and transfer the information to the memory 203 and the processor 207. For instance, the control interface 211 may contain hardware and logic implementing a 100 megabit Ethernet port. The control interface 211 may also use communication paths 233 to report the status information 145 to an entity connected to the network, such as an element management system. Additionally, communication paths 233 may be used to report some or all of the quality of experience metric 135.

The network interface 209 and the control interface 211 may be separate physical interfaces to different or the same networks. Alternatively, the network interface 209 and the control interface 211 may share the same physical connection to the same network with the handling of inputs and outputs differentiated by logic.

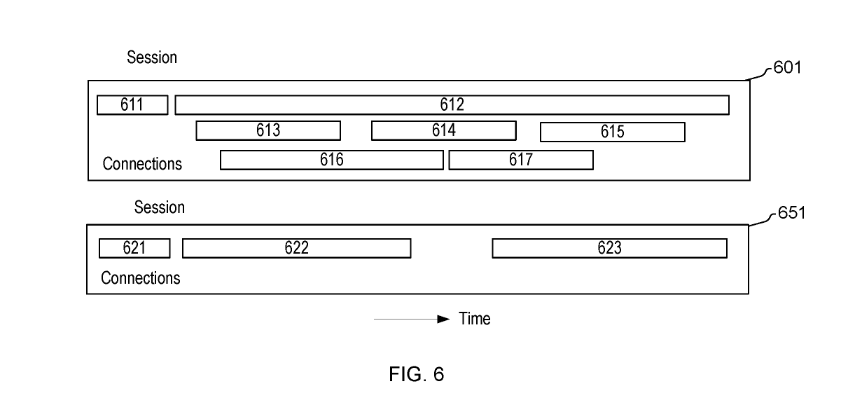

FIG. 6 illustrates relationships between sessions and connections. In particular, a session may be made up of one or more connections. Some connections within a session may be sequential in time. Some connections within a session may be overlapping in time.

Connections may be made up of one or more Internet protocol (IP) packets. Packets may be associated with a connection if they share the same 5-tuple and the inter-arrival time between packets with the same 5-tuple does not exceed a threshold. The 5-tuple of an IP packet is the source IP address, source port, destination IP address, destination port, and transport protocol used, for example transmission control protocol (TCP) or user datagram protocol (UDP).

A session is a set of connections that combine to provide a service or application to a user. For instance, session 601 may be a streaming video such as Netflix. When a user is viewing a streaming video, transmission of the video from a content server (e.g., the content server 110) to a user device (e.g., the user device 105) may include many connections. For example, each segment of a few seconds of video may be transported on a different connection. Some of these connections may be sequential in time such as connections 611 and 612. Some of these connections may be overlapping in time such as connections 612, 613, and 616. Information such as the packet information 125 may be used to determine which connections belong to which session.

Session 651 depicts a simpler service, such as a simple email application. Due to lapses in activity, session 651 may be broken into multiple sequential connections 621, 622, and 623, but there may be few or no connections that overlap in time.

Note that the connections that make up a session may have different sources or destinations and may flow in different directions. For instance, connection 611 may be a request to a content server from a user device while connection 612 may be video data from a content server to the user device. Alternatively, a connection may include information flow in more than one direction. For example, a TCP connection between a client and a server may contain hypertext transfer protocol (HTTP) request messages flowing from the client to the server and HTTP response messages flowing from the server to the client. This same connection may further contain TCP acknowledgment information supporting both HTTP request messages and HTTP response messages, but flowing in a direction opposite to the HTTP messages.

As described above with respect to FIG. 1, the content server 110 may include a number of physical devices geographically distributed and having different IP addresses. They may work together to send and receive the packets that realize the service. For instance, connections 613, 614, and 615 may be from one source IP address while connections 616 and 617 may be from a second IP address.

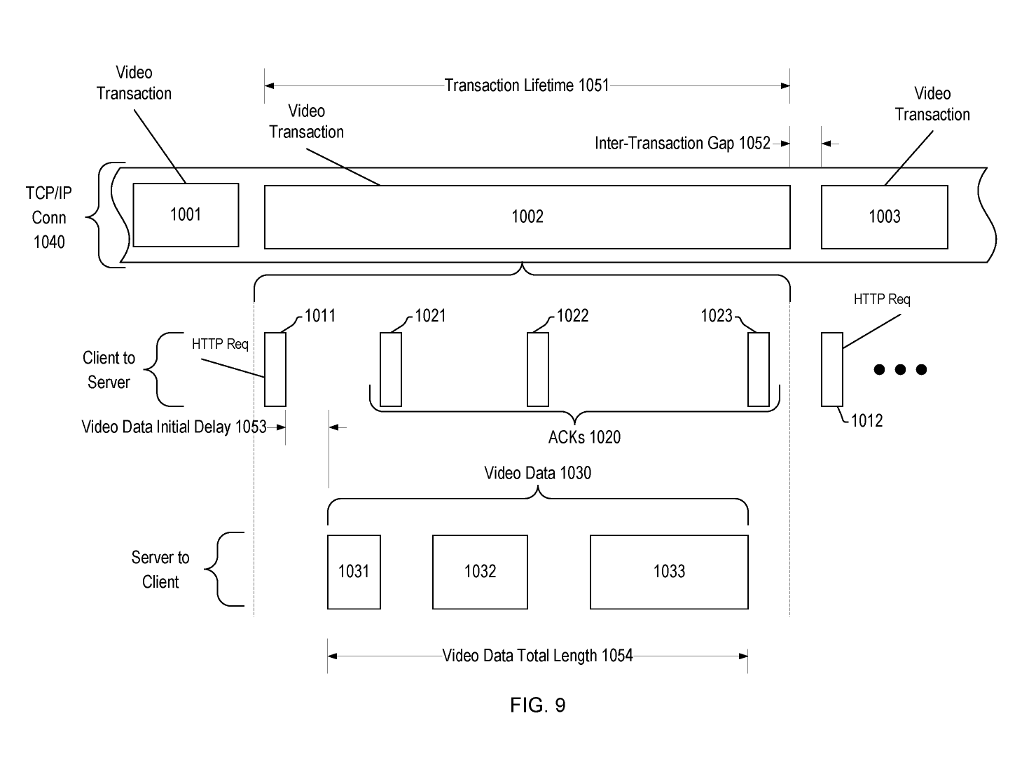

As mentioned above, connections may be made up of one or more IP packets. For the connections making up a video session, the IP packets may be TCP/IP packets grouped into video transactions. FIG. 9 illustrates elements of an exemplary video transaction. A TCP/IP connection that is part of a video session includes one or more video transactions. For instance, a TCP/IP connection 1040 shown in FIG. 9 includes a present video transaction 1002, a previous video transaction 1001, and a subsequent video transaction 1003. Video transactions are initiated with an HTTP Request (or “HTTP Req”) from a video client to a video server. A first HTTP request 1011 initiates the present video transaction 1002 while a subsequent HTTP request 1012 initiates the subsequent video transaction 1003. In response to the first HTTP request 1011, the video server starts transmitting video data 1030. The video data 1030 may be transmitted in one or more transmissions, for example, video data transmissions 1031, 1032, and 1033, each including one or more TCP/IP packets. The video data transmissions 1031, 1032, and 1033 are acknowledged by acknowledgments 1021, 1022, and 1023, respectively.

Video transaction statistics may be measured or computed and used to ascertain the quality of a video session in the presence of end-to-end encryption. Exemplary statistics include transaction lifetime 1051, inter-transaction gap 1052, video data initial delay 1053, video data total length 1054, and the relationship between transaction lifetime 1051 and video data total length 1054.

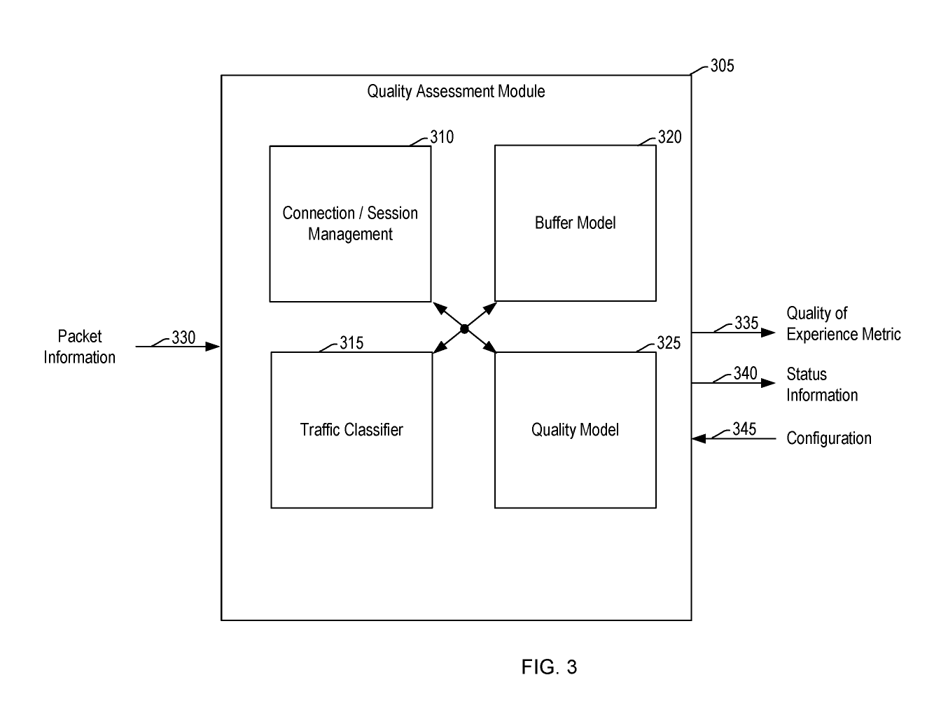

FIG. 3 is a block diagram of a quality assessment module 305 that may be used for the quality assessment module 130. The quality assessment module 305 may include a connection/session manager 310, a buffer model 320, a traffic classifier 315, and a quality model 325. Together these components, as configured by a configuration 345, enable the quality assessment module 305 to receive packet information 330 and transform it into a quality of experience metric 335.

The packet information 330 may include identification information such as source and destination IP addresses, port numbers, and protocol identifiers. The packet information 330 may include packet statistics such as packet sizes, packet arrival times, packet inter-arrival times, and direction of packet flow. The packet information 330 may include associations between identification information and packet statistics. The quality of experience metric 335 may include information such as video mean opinion score (VMOS), duration of a video stream, initial buffering delay, and re-buffering stall statistics such as time, duration, frequency, and time between re-buffering stalls. The quality of experience metric 335 may include information such as playback bitrate, screen resolution, transport bitrate, packet retransmission rate, and packet latency. The quality of experience metric 335 may include event information including changes to the video spatial resolution and playback representation changes. The quality of experience metric 335 may include event information related to user actions such as player fast forward, rewind, and pause. A quality of experience metric may include information related to other user actions such as the opening of sessions or connections for other services (e.g., email or social media) during a video session.

The quality of experience metric 335 may provide information for individual video sessions or may be combined for groups of video sessions. The quality of experience metric 335 may be reported periodically or may be reported for a video session as a whole.

The connection/session manager 310 groups multiple connections via identification information (e.g., destination IP address) into one or more sessions. This grouping may be performed prior to classification by the traffic classifier 315; however, the results of traffic classification may be used to adjust the mapping. For example, the traffic classifier 315 may learn that only a subset of connections with a common destination IP address are associated with a streaming video session. Once classified by the traffic classifier 315, the knowledge that a particular streaming video is running can be used by the connection / session management 310 to add or remove connections to or from a session.

The connection/session manager 310 additionally may derive or extract some of the features fed to the traffic classifier 315 and the buffer model 320. Some features may be provided directly in the packet information 330. Other features may need to be derived, based on the packet information 330, in particular ‘stateful’ features or features related to a session. Example features that may be derived or extracted include: current, average, min and max number of concurrent connections; current, average, min and max duration of a connection; total cumulative number of connections; timestamp information for connection start and stop; packets per connection; bytes per connection; packets per session; and bytes per session.

Features may be determined separately for uplink (UL) and downlink (DL) traffic. Features may be created per detected video session (e.g., based on packet information received for connections associated with a session). A feature may be directly extracted from the packet information 330 or derived from the packet information 330 depending on the composition (statistics versus time-stamped packets) of the packet information 330.

The traffic classifier 315 determines which sessions are video sessions. The traffic classifier 315 may also determine the specific video application of a session, for instance, Netflix or YouTube. The traffic classifier 315 may use methods such as those described in U.S. Pat. No. 9,380,091, U.S. Patent Publication No. 2015/021539, or other methods and techniques to use packet information 330 to determine that a session carries video and the specific video application used. However, in the presence of end-to-end encryption some of the information used in prior methods may not be available to the traffic classifier 315. The traffic classifier 315 may use packet statistics included in the packet information 330 to enable or improve its ability to detect video and specific video applications. The traffic classifier 315 may receive weights in the configuration 345 and use the weights as initial values to configure a neural network or machine learning algorithm (the combination hereafter referred to as a ‘neural network’) to classify the data traffic. The traffic classifier 315 may extract features, for example, packet statistics and identification information, from the packet information 330 and use these features as inputs to the neural network. The traffic classifier 315 may use a combination of a neural network and methods such as found in U.S. Pat. No. 9,380,091 and U.S. Patent Publication No. 2015/021539 to classify traffic.

For sessions that are classified by the traffic classifier 315 as video, the buffer model 320 models the behavior of the video client associated with the session to estimate the state of the video client's video playback buffer. This modeling allows the buffer model 320 to determine such information as initial buffering delay, whether the video is stalled and re-buffering, and other video state information such as rewind, pause, and fast-forward. Because the information necessary to use methods such as those described in U.S. Pat. No. 9,380,091 and U.S. Patent Publication No. 2015/021539 may not be available in the packet information 330 for sessions with end-to-end encryption, the buffer model 320 may use artificial intelligence methods to model the video playback buffer for a video session. The buffer model 320 may receive weights in the configuration 345 and use the weights to configure a neural network to model the state of a video playback buffer. The buffer model 320 may use features of a session from the packet information 330, for example, packet sizes and packet arrival times, as input to the neural network or any of the features described above with respect to the connection/session manager 310 (e.g., packets per session, current number of connections per session, etc.).

Alternatively to the above example of neural networks, the buffer model 320 or the traffic classifier 315 may use any of a number of machine learning based classification algorithms, such as decision trees, bagged trees, linear support vector machines (SVM) or k-nearest neighbors. Multiple learning algorithms may be used in parallel with results selected based on relative confidences attributed to the output of each algorithm. The multiple learning algorithms may be the same algorithm (e.g., three decision trees) with each algorithm using a unique set of training weights, different algorithms (e.g., decision tree and SVM), or a combination of the two. Additional techniques may be employed in conjunction with the above algorithms to further improve performance, in particular for imbalanced training datasets. For example, synthetic minority over-sampling technique or adaptive boosting may be used in conjunction with decision trees to improve performance.

The quality model 325 uses a combination of the video session state generated by the buffer model 320 and the video class or application information generated by the traffic classifier 315 to determine a video quality score, such as mapping the information to a video mean opinion score (VMOS). The video quality score for a video session may take into account a previous video quality score for the session.

The quality of experience metric 335 for multiple sessions may be combined to provide an aggregate assessment of the quality of experience enjoyed by users of the network. Similarly, quality of experience metrics output by multiple quality assessment modules may be combined to provide an aggregate assessment of the quality of experience enjoyed by users of the network. The quality of experience metrics output by multiple quality assessment modules may be compared to provide a relative assessment of the quality of experience enjoyed by users in different parts of the network. Such aggregations and comparisons may be for all video or separately for different video applications.

The status information 340 may include information relating to the performance of the quality assessment module 305. For example, the status information 340 may include information describing the statistical confidence of the quality of experience metric 335, which may then be used to alert a system administrator when the buffer model 320 or the traffic classifier 315 of the quality assessment module 305 is performing poorly. The status information 340 may include system resource usage information which may report memory, processor, and network utilization of the quality assessment module 305. Such information may be used by a system administrator to adjust packet information sampling/filtering rates or the amount of hardware resources being allocated to the quality assessment module 305.

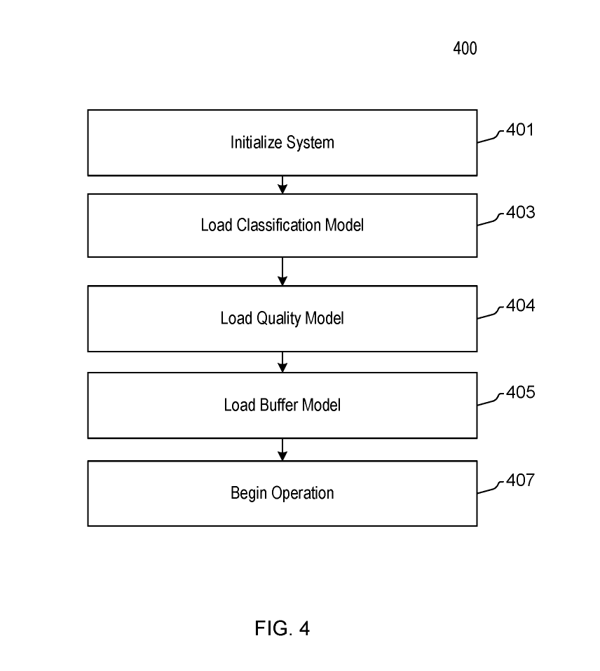

FIG. 4 is a flowchart of a process for initialization of a quality assessment module. The process may be used with any suitable apparatus; however, to provide a specific example, the process will be described with reference to the quality assessment module 305. At step 401, the system is initialized, including the initialization of the device, such as the network device 200 which implements the quality assessment module 305. Step 401 may also include initialization of the communication paths 223 over the network interface 209 and communication paths 233 over the control interface 211.

After system initialization, the process proceeds to step 403 where the classification model or classification model configuration and parameters are loaded, for instance from the configuration 345 into the memory 203 for use by the traffic classifier 315. This may include loading neural network parameters, machine learning configuration, special versions of software, or some combination thereof.

At step 404, the quality model or quality model configuration and parameters are loaded, for instance from the configuration 345 into the memory 203 for use by the quality model 325. This may include loading neural network parameters, machine learning configuration, special versions of software, or some combination thereof.

At step 405, the buffer model or buffer model configuration and parameters are loaded, for instance, from the configuration 345 into the memory 203 for use by the buffer model 320. This may include loading neural network parameters, machine learning configuration, special versions of software, or some combination thereof.

Steps 403, 404, and 405 are shown sequentially in FIG. 4. They may be in a different order, simultaneous, or overlapping in time and may overlap with elements of step 401. Additionally, one or more of the classification model, the classification configuration and parameters may be updated during system operation. Additionally, one or more of the buffer model, buffer model configuration and parameters may be updated during system operation.

At step 407, after the system is initialized and the classification model and buffer model are configured, the quality assessment module 305 begins operation, detecting video sessions and deriving a quality of experience metric.

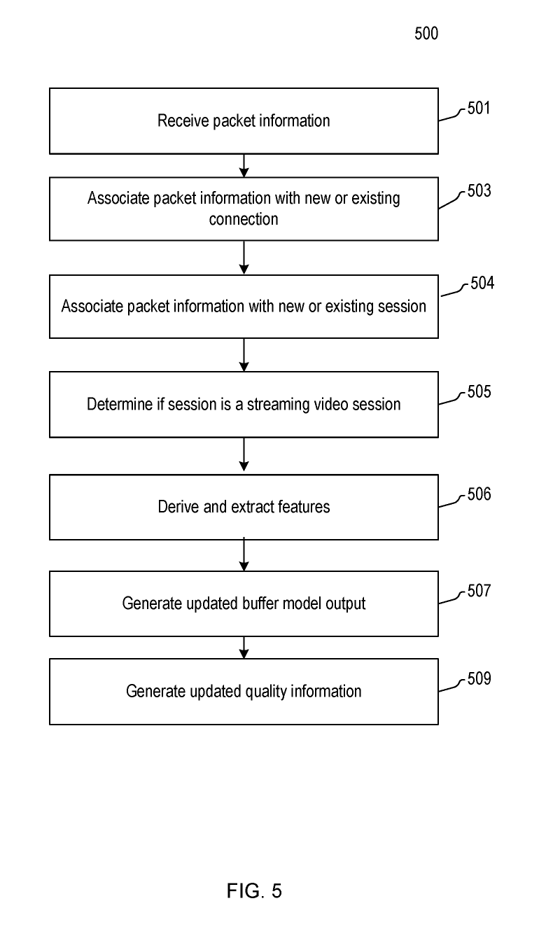

FIG. 5 is a flowchart of a process for quality assessment. The process may be used with any suitable apparatus; however, to provide a specific example, the process will be described with reference to quality assessment module 305. The process may be repeatedly executed periodically on the packet information 330 received within a time interval or may be event driven as individual portions of the packet information 330 are received. The steps may be performed in real-time, delayed, in a post-processing mode, or a combination thereof. For instance, certain features, such as the transaction lifetime 1051 and the video data total length 1054 depicted in FIG. 9, can only be ascertained after a transaction is complete.

The packet information 330 is received at step 501. At step 503, the received packet information is associated with a connection. This is performed, for instance by the connection/session manager 310 matching the 5-tuple information for the packet information with that of a known existing connection. If a match is made, the packet information is associated with that connection. If no match is made (e.g., the 5-tuple combination has never been seen or has been seen but too far in the past) a new connection may be deemed to exist and the information is associated with the new connection.

At step 504, the received packet information is associated with a session. In the case that the packet information is associated with a connection already associated with a known session, the packet information is associated with the same known session. In the case that the packet information is associated with a connection not yet associated with a known session, the connection/session manager 310 attempts to associate the connection, and therefore, the packet information, with a new session. Connections may stay sessionless for some time, for instance when encountering an application unknown to the traffic classifier 315 or for an application that takes multiple packets to classify.

At step 505, the process determines whether the session is a streaming video session if not already determined in a previous iteration of step 505. Connections may be grouped into sessions without application classification, for instance when the application is unknown to the traffic classifier 315. This may be done, for instance, by the traffic classifier 315 using the classification model loaded at step 403.

At step 506, the connection/session manager 310 additionally may derive or extract some of the features to be fed to the traffic classifier 315 and the buffer model 320. Some of these features may be provided directly in the packet information 330. Other features may need to be derived, in particular ‘stateful’ features or features related to a session. Example features derived or extracted include: current, average, minimum and maximum number of concurrent connections; current, average, minimum and maximum duration of a connection; total cumulative number of connections; timestamp information for connection start and stop; packets per connection; bytes per connection; packets per session; and bytes per session.

Features may be determined separately for UL and DL traffic. Features may be created per detected video session (e.g., based on packet information received for connections associated with a session). A feature may be directly extracted from the packet information 330 or derived from the packet information 330 depending on the composition (statistics versus timestamped packets) of the packet information 330.

Alternatively or additionally, features may be based on the video transactions of a video session, as described in regard to FIG. 9. Such features may be referred to as transaction features.

A number of techniques may be used at the beginning of step 506 to filter TCP/IP connections that may be related to a particular video session, but omitted from feature extraction. These filtered TCP/IP connections include:
1. TCP/IP connections that carry total traffic bytes below a certain threshold may be filtered out. The connection may be assumed to be carrying video traffic while the total traffic bytes is being calculated. If the byte count does not meet the threshold criteria, the connection is dropped from the list of video connections.
2. TCP/IP connections that have a video data total length below a certain threshold may be filtered out, even if the total number of bytes is large. The connection may be assumed to be carrying video traffic while the video data total length is being calculated. If the byte count does not meet the threshold criteria, the connection is dropped from the list of video connections.
3. TCP/IP connections that have traffic from the client to the server other than HTTP requests and TCP acknowledgments may be filtered out since video connections carry data only from the server to the client except for the HTTP requests and TCP acknowledgments.
4. TCP/IP connections that are not end-to-end encrypted (e.g., not TLS based—destination port not equal to 443) may be filtered out. If video is carried without end-to-end encryption, other techniques (such as deep packet inspection based techniques) can be used to detect TCP connections carrying video.
5. In some video applications, the HTTP request may be a constant number of bytes or in a narrowly bounded range. In the case of Netflix video transactions, for instance, the HTTP request typically is in the range of 700-725 bytes, not including the IP and TCP headers. If most HTTP requests are in the range of 700-725 bytes, the associated connections may be considered to be part of a video session. The first transactions of a video session may not follow this pattern since they may be used to establish the secured link rather than initiate video data transfers. So a number of transactions for a connection may need to be observed before the associated session is determined to carry video.

At step 507, the change in system state represented by the packet information 330 may be run through the buffer model 320, loaded in step 405, and transformed into a new buffer model output. The buffer model output may be transformed into an indication of the state of the video session. Example states of a video session include not stalled, stalled due to congestion, stalled due to initial buffering, stalled due to user pause of the video, stalled due to user fast-forward of the video, or stalled due to user rewind of the video. This indication may be generated periodically or updated upon change of state. Indications may be post-processed for temporal relationships to further refine the indication. For instance, since video re-buffering normally takes a certain period of time, stalls due to congestion that are shorter than a certain time period, for instance five seconds, may be filtered out as false alarms.

In step 509, the buffer model output is input to the quality model 325 and transformed into an updated quality of experience metric 335.

Features may be extracted or derived on a per transaction basis every sample period in the connection/session manager 310. A sample period is a time duration over which sampling and derivation of features occurs, for example 0.5 seconds, 1 second, etc. The sample period may be a function of the line rate of the network being monitored, or it may be a function of the expected average video bit rate. If a TCP/IP connection has no complete transactions and has no partial transactions (end of previous, start of next) during a sample period, there will be no features extracted or derived for that TCP/IP connection. For each transaction or partial transaction on a TCP/IP connection during the sample period, a sample containing one or more extracted or derived features may be generated. This generates a sample per transaction per sample period. The samples are input to, for instance, the buffer model 320 and the quality model 325.

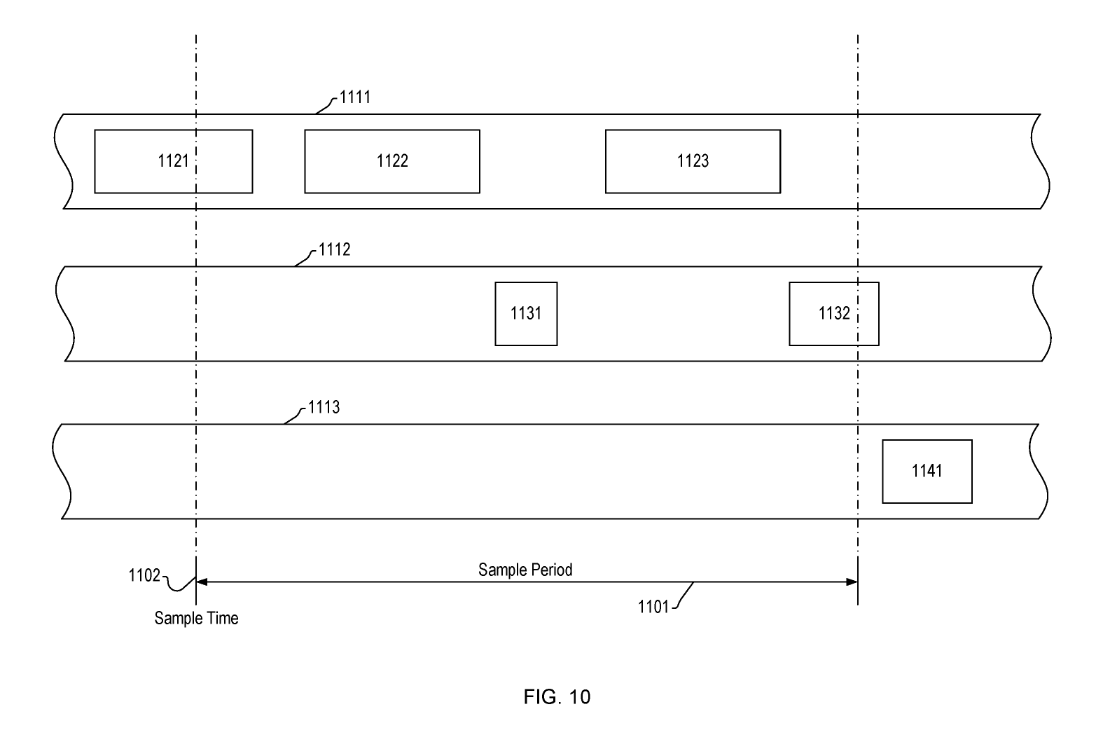

FIG. 10 illustrates a sample period 1101 starting at sample time 1102. The number of connections and transactions and their alignment with sample period 1101 is an example for explanatory purposes. Any numbers of connections and transactions and many alignments are possible. FIG. 10 shows three TCP/IP connections 1111, 1112, and 1113. TCP/IP connection 1111 has a transaction 1121 ending during the sample period 1101 and two transactions 1122 and 1123 fully contained within the sample period 1101. TCP/IP connection 1112 has a transaction 1131 fully contained within the sample period 1101 and a transaction 1132 that starts during the sample period 1101 but does not complete within the sample period 1101. TCP/IP connection 1113 does not have any transactions within or overlapping the sample period 1101.

A sample may be created for each of transactions 1121, 1122, 1123, 1131, and 1132 for sample period 1101, that is, a sample per transaction per sample period. No samples would be generated for TCP/IP connection 1113 during sample period 1101 since it has no transactions active during the sample period. The samples may have different features extracted based on the relationship of the transaction to the sample period 1101. For instance, the sample for transaction 1121 during sample period 1101 may have a transaction end time feature extracted but no transaction start time feature extracted. The sample for transaction 1132 may have a transaction start time feature extracted but no transaction end time feature extracted. The samples for transactions 1122, 1123, and 1131 during sample period 1101 may all have both a transaction start time feature and a transaction end time feature extracted.

The creation of a sample may be delayed so that information about partially completed transactions or information about future transactions can be included in the sample. For example, the creation of a sample may be delayed so that the end time feature for transaction 1132 may be included for sample period 1101.

In addition or instead of features related to transactions, the creation of a sample every sample period may be applied to features relating to TCP/IP connections or video sessions.

Features may occur at different levels of a video session. For instance, features may be associated with the overall session, a connection, or a transaction. Features may be temporal in nature or reflect a size or quantity. Features may reflect history.

In an embodiment, one or more of the following features may be extracted or derived during a sample period, for example, at step 506 of the flowchart in FIG. 5:
1. Transaction start time—this feature represents the start time (for example, a number in seconds) of the transaction. The time reference is the beginning of the video session.
2. Transaction end time—this feature represents the end time of the transaction. The time reference is the beginning of the video session.
3. Transaction relative start time—this feature represents the transaction start time relative to the current sample time.
4. Transaction relative end time—this feature represents the transaction end time relative to the current sample time.
5. TCP/IP connection relative start time—this feature represents the TCP/IP connection start time relative to the current sample time.
6. TCP/IP connection relative end time—this feature represents the TCP/IP connection end time relative to the current sample time.
7. Transaction lifetime (e.g., transaction lifetime 1051)—this feature represents the length of the video transaction. It is the difference between the transaction end time and transaction start time features.
8. Video data initial delay (e.g., video data initial delay 1053)—this feature represents the time difference between the HTTP request issued by the client and the first response from the server with data (e.g., video data transmission 1031).
9. Video data total length (e.g., video data total length 1054)—this feature represents the total time duration of the downlink data transfer for a transaction. It is measured as the time, for instance in seconds, between the client reception of the last byte of video data (e.g. video data transmission 1033) and the first byte of video data (e.g., video data transmission 1033).
10. Inter-transaction gap—this feature represents the gap between a transaction (e.g., current video transaction 1002) and the following transaction (e.g., next video transaction 1003) on the same TCP/IP connection. This feature may be measured as the time difference between the client reception of the last downlink byte for the current transaction and the client issuance of a new HTTP request for a following video transaction on the same connection. Alternatively, this feature may be measured as the time difference between the client sending the last acknowledgment of a transaction and the client issuance of a new HTTP request for a following video transaction on the same connection. This feature shows the aggressiveness of the client requesting data.
11. Video data size—this feature describes the total number of bytes of video data sent in a transaction from the video server to the client within the current sample period. The video data size feature may not include the count of bytes in network headers such as Ethernet, IP, and TCP headers. The video data size feature may include the count of bytes in HTTP and TLS headers. The video data size feature may be used to further derive an instantaneous bit rate feature for the associated TCP/IP connection.
12. Client data size—this feature is the total number of bytes sent in a transaction from the client to the server within the current sample period. The client data size feature may not include the count of bytes in network headers such as Ethernet, IP, and TCP headers. The client data size feature may include the count of bytes in HTTP and TLS headers.
13. TCP/IP switch count history in Last N seconds—this feature represents the number of switches between transactions on different TCP/IP connections within the last N seconds (e.g.,5 or 10 seconds). The switch between different TCP/IP connections happens when a transaction in one TCP connection is followed by a transaction on a different TCP/IP connection of the same video session. A client may do this when the network performance of one TCP/IP connection is not satisfactory, and hence, it tries to distribute its requests on multiple TCP/IP connections. The client may then close the TCP/IP connection that is not well-performing, or keep using the multiple TCP/IP connections in parallel. A number of similar features, each looking back different time periods, or different time ranges such as the previous 5-10 seconds, may be derived.
14. Mean video data downlink bytes history—this feature represents the average number of video data (e.g., video data 1030) bytes per second in the last N seconds (e.g., 5 or 10 seconds) for a video session. A number of similar features, each looking back different time periods, or different time ranges such as the previous 5-10 seconds, may be derived.
15. FIN-RESET event indication—this feature indicates whether the RESET part of a FIN-RESET event occurred during a sample period. A FIN-RESET event is defined as when the client closes a video carrying TCP/IP connection by sending a FIN packet to the server but does not wait for an acknowledgment from the server, but rather follows the FIN packet with a RESET packet. A FIN-RESET event may occur on a different TCP/IP connection of the video session.
16. Video byte count since last FIN-RESET—this feature represents the number of bytes of video data (e.g., video data 1030) transmitted on all TCP/IP connections of a video session since the most recent FIN-RESET closing a TCP/IP connection associated with the video session.
17. FIN-RESET history—this feature indicates whether there were other FIN-RESET events within the last N seconds (e.g., 5 or 10 seconds) for the same video session.
18. Estimated playback buffer—this feature is an estimate of the client playback buffer size in seconds for a video session. It may be calculated as follows:
   a. Count total number of video transactions that were completed for this video session by the time of the current sample. This includes all transactions on TCP/IP connections carrying video since the beginning of the video session.
   b. Correct the count of video transactions by removing an estimate of audio transactions. This is an optional step to improve accuracy of the estimate. Detecting the number of audio transactions can be done by several methods including running a classifier for audio traffic. Another method is to have a coarse estimate of the audio transactions by assuming each audio transaction carries a fixed number of seconds of audio.
   c. Calculate the relative time=(current sample time)−(sample time for the first transaction).
   d. Each video transaction represents typically represents a fixed number of seconds T of playback (which may differ for different applications), hence the estimated playback buffer (in playback time in seconds) is calculated as (total number of video-only transactions)×4- (relative time).

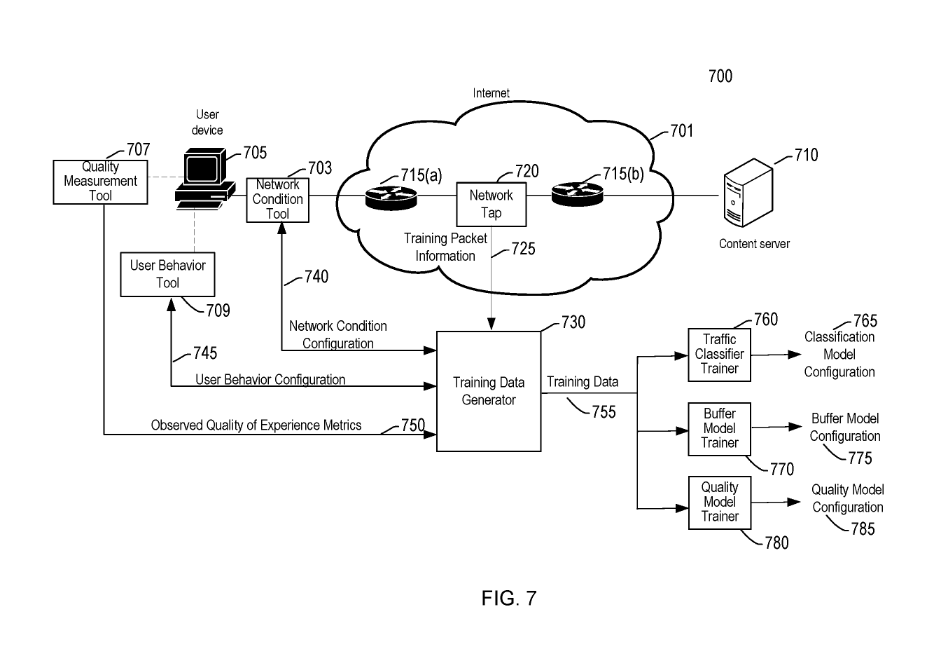

FIG. 7 is a block diagram of a system 700 for generating configuration data for quality assessment. For instance, system 700 may be used to generate neural network weights or other model configuration data loaded to the quality assessment module 305 as part of the configuration 345. This may include generation of a classification model configuration 765 for the traffic classifier 315 or a buffer model configuration 775 for the buffer model 320. Generating the configuration data may be referred to as training.

A content server 710 provides video content that may be viewed by a user on a user device 705. The content server 710 may be, for example, a single server, a number of servers that provide different portions of a video stream, a content delivery network (CDN), data caches, or a combination thereof. The user device 705 may be of various forms, such as a smartphone, a tablet, a laptop, a smart television, a television connected to a streaming video device, or a desktop computer. For the purposes of generating configuration data, the user device 705 may be instrumented with special test capabilities. For instance all or a portion of a quality measurement tool 707, a user behavior tool 709, and a network condition tool 703, may be implemented in the user device 705.

Video data may be streamed from the content server 710 to the user device 705 via the Internet 701. The user device 705 and the content server 710 may connect to the Internet 701 via an access network such as provided by a mobile network operator, a cable operator, a DSL operator, or another Internet service provider (ISP). An enterprise network or intranet may connect the content server 710 and the user device 705. Connectivity through the Internet 701 may pass through one or more routers 715. A network tap 720 derives training packet information 725 (similar to the packet information 125 of FIG. 1 or the packet information 330 of FIG. 3) from the packets flowing between the content server 710 and the user device 705. The network tap 720 may partially or fully provide the set of features needed to train the model. Alternatively, the network tap 720 may provide the training packet information 725 which may be used by a training data generator 730 to generate features.

The network tap 720 is shown as a separate device to the example of FIG. 7. The network tap 720 may be a network tap device such as the Datacom FTP-1516 40G Multi-Wavelength Fiber Tap. Alternatively, the network tap 720 may be a network packet broker, may be incorporated as functionality in the router 715, or may take other forms. The network tap 720 is shown in the Internet 701 in the example of FIG. 7. The network tap 720 may be placed in any of various locations between the content server 710 and the user device 705, including an access network or an enterprise network.

A network condition tool 703 and the user behavior tool 709 may be used to set up the conditions under which to capture the training packet information 725. The network condition tool 703 is used to create network conditions or simulate network conditions that may affect the operation of the video client in the user device 705. For instance, the network condition tool 703 may be configured by the network condition configuration 740 to limit bandwidth to and from the user device 705, limit bandwidth for specific connections, drop or delay packets from specific connections, randomly drop or delay packets, and so on. A network condition configuration 740 may cause these actions to vary over the course of training. The network condition tool 703 may be embedded in the user device 705 or may be implemented in a standalone device. The network condition tool 703 may be implemented, for example, using the Linux traffic control capability. The network condition configuration 740 used to configure or control the network condition tool 703 may be supplied, for example, via scripts or a user interface. The network condition tool 703 may be configured or controlled independent of the user behavior tool 709 or jointly with the user behavior tool 709. The network condition configuration 740 may be optionally available to the training data generator 730.

The user behavior tool 709 is used to inject user actions into the training process at certain times. For instance, a user behavior configuration 745 may be used by the user behavior tool 709 to cause the user device 705 to start one or more specific videos, and perform actions such as rewind, pause, fast forward, and early shutdown. The user behavior tool 709 may also initiate other services before, during, or after the video is playing. These other services may be background tasks (e.g., refresh email) or operate in the foreground (e.g., launch a browser). The user behavior tool 709 may be embedded in the user device 705 or may be implemented in a standalone device. The user behavior configuration 745 used to configure or control the user behavior tool 709 may be supplied via scripts or through a user interface. The user behavior tool 709 may be configured or controlled independent of the network condition tool 703 or jointly with the network condition tool 703. The user behavior configuration 745 may be supplied to the training data generator 730 so the training data generator 730 may associate user actions with the training packet information 725 when transforming the information and configurations received into the training data 755.

It is desirable that a particular pass through the training process be repeatable, for instance, allowing it to be run against the trained system of FIG. 1 to check the training. In an embodiment, scripts or an alternate automated process are used to jointly control the network condition tool 703 and the user behavior tool 709.

A quality measurement tool 707 collects observed quality of experience metrics 750 and provides the observed quality of experience metrics 750 to the training data generator 730 for association with the training packet information 725 and the user behavior configuration 745. The quality measurement tool 707 may be, for instance, a video client in the user device 705 which provides statistics such as video client buffer occupancy, initial buffer delay, current or average bit rate, video representation selection, playback resolution, playback frames per second, and re-buffering (stall) event occurrences and durations, any or all of which may be present in the observed quality of experience metrics 750. The quality measurement tool 707 may include a “screen scraper” or tool to interface with graphical user interface display objects (e.g., appium, selenium) which detects the state of the display of the user device 705 and deduces statistics that may be included in the observed quality of experience metrics 750.

The training data generator 730 accepts the training packet information 725, the observed quality of experience metrics 750, and some or all of the user behavior configuration 745. The training data generator 730 may also accept the network condition configuration. The training data generator 730 may transform the training packet information 725, for instance from whole packets to statistics about packets or to samples containing features extracted or derived about transactions. The training data generator 730 performs associations (e.g., temporal associations) between its inputs and creates the training data 755. All or a portion of the training data 755 is input to the traffic classifier trainer 760, the quality model trainer 780, and the buffer model trainer 770. The buffer model trainer 770 transforms the applicable portion of the training data 755 into the buffer model configuration 775, for instance using techniques for supervised neural network training. The buffer model configuration 775 may be used as part of the configuration 345 and loaded in step 405 of the process of FIG. 4.

The traffic classifier trainer 760 transforms the applicable portion of the training data 755 into the classification model configuration 765, for instance using techniques for supervised neural network training. The classification model configuration 765 may be used as part of the configuration 345 and loaded in step 403 of the process of FIG. 4.

The quality model trainer 780 transforms the applicable portion of the training data 755 into the quality model configuration 785, for instance using techniques for supervised neural network training. The quality model configuration 785 may be used as part of the configuration 345 and loaded in step 404 of the process of FIG. 4.

Training with the system 700 may be performed over many combinations of the network condition configurations 740 and the user behavior configurations 745. Additionally, training may be performed using a variety of video services such as Netflix and YouTube and a variety of non-video services such as email, web browsing, or the use of non-video applications. Training may be performed over a variety of the user device 705, such as an iPhone or iPad, Android phone or tablet. Training may be performed using a browser to start and view the video session or using an app for the video service. Training may be performed by accessing the content server 710 via different ISPs and from different geographic locations.

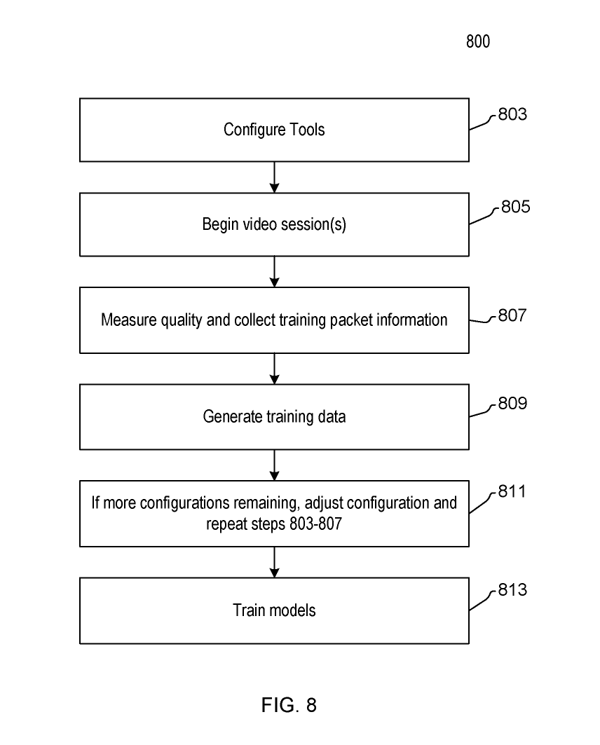

FIG. 8 is a flowchart of a process 800 for creating one or both of the classification model configuration 765 and the buffer model configuration 775. At step 803, the tools are configured. For instance, the network tap 720 may be configured to filter, process, or analyze packets meeting certain criteria. The network condition tool 703 may be configured with the network condition configuration 740. The user behavior tool 709 and the training data generator 730 may be configured with the user behavior configuration 745. The quality measurement tool 707 may be configured to be in a certain mode.

At step 805, one or more video sessions are started. For instance, the user behavior tool 709, as configured by the user behavior configuration 745, may begin one or more video sessions. The video sessions may be started simultaneously or may have their start staggered to emulate different scenarios over which to train.

At step 807, the training packet information 725 and the observed quality of experience metrics 750 are collected. In step 809, the inputs to the training data generator 730 are transformed into the training data 755.

Steps 807 and 809 are shown after step 805 for convenience. However, the collection process of step 807 and the generation of training data in step 809 may start prior to starting any video sessions and may continue until after the video sessions are terminated.

At step 811, steps 803 through 809 are repeated if more training configurations remain.

At step 813, the training data 755 is fed into one or more of the traffic classifier trainer 760, the quality model trainer 780 and the buffer model trainer 770 to generate one or more of the classification model configuration 765, the quality model configuration 785, and the buffer model configuration 775, respectively. The models may be trained incrementally. The process may generate the training data 755 from many training sessions and then feed them into the trainers. Alternatively, the training data 755 may be fed into the traffic classifier trainer 760 and the buffer model trainer 770 incrementally, for example, as the data becomes available. In this case, step 813 would occur before step 811 and be iterated with steps 803 through 809.

The foregoing systems and methods and associated devices and modules are susceptible to many variations. Additionally, for clarity and concision, many descriptions of the systems and methods have been simplified. For example, the figures generally illustrate one of each type of device (e.g., one user device, one server), but a system may have many of each type of device. Similarly, descriptions may use terminology and structures of a particular communication network; however, the disclosed systems, devices and methods are more broadly applicable to different types of wireless and wired communication systems, including for example, to hybrid fiber-coax cable modem systems.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps and modules described in connection with the embodiments disclosed herein can be implemented or performed with a processor. As used herein a processor may be a general purpose processor, a digital signal processor (DSP), an application specific integrated circuit (ASIC), a field programmable gate array (FPGA) or other programmable logic device, discrete gate or transistor logic, discrete hardware components, or any portion or combination thereof that is capable of performing the functions described herein. A general purpose processor can be a microprocessor, but in the alternative, the general purpose processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, device, blocks, or modules that are described as coupled may be coupled via intermediary device, blocks, or modules. Similarly, a first device may be described as transmitting data to (or receiving from) a second device when there are intermediary devices that couple the first and second device and also when the first device is unaware of the ultimate destination of the data.

The above description of the disclosed embodiments is provided to enable any person skilled in the art to make or use the invention. Various modifications to these embodiments will be readily apparent to those skilled in the art, and the generic principles described herein can be applied to other embodiments. Thus, it is to be understood that the description and drawings presented herein represent present example embodiments of the invention and are therefore representative of the subject matter that is broadly contemplated by the present invention.

What is claimed is:

1. A method for determining a quality of experience metric associated with a video stream being played at a terminal node, the method comprising:
receiving packets associated with the video stream, the packets being transmitted from a video server to the terminal node, at least some of the packets being encrypted;
deriving packet information from the packets, the packet information including identification information and packet statistics;
extracting video stream features based on the packet information;
estimating an occupancy level of a video playback buffer associated with the video stream in the terminal node, the occupancy level being estimated using the video stream features; and
generating the quality of experience metric based at least in part on the estimated occupancy level of the video playback buffer in the terminal node.

2. The method of claim 1, wherein the occupancy level of the video playback buffer is estimated utilizing a machine learning process.

3. The method of claim 1, wherein the quality of experience metric is generated utilizing a machine learning process.

4. The method of claim 3, further comprising loading a configuration including initial values for the machine learning process.

5. The method of claim 1, wherein the video stream is conveyed to the terminal node in one or more video transactions, each video transaction including transmission of a request from the terminal node and then transmission of one or more of the packets to the terminal node, wherein the video stream features include transaction features associated with the one or more video transactions.

6. The method of claim 5, wherein the transaction features of the one or more video transactions include temporal features.

7. The method of claim 5, wherein the transaction features of the one or more video transactions include one or more transaction features selected from the group consisting of transaction start time, transaction end time, connection start time, connection end time, transaction lifetime, video data initial delay, video data total length, inter-transaction gap, and video data size.

8. The method of claim 1, wherein the video stream features are extracted for a sample period.

9. The method of claim 1, wherein the quality of experience metric is generated for a sample period.

10. The method of claim 1, further comprising analyzing the packet information to:
identify connections associated with the packets based on the identification information;
group the identified connections into sessions that provide a service to the terminal node; and
classify which sessions are associated with the video stream.

11. The method of claim 1, wherein the quality of experience metric includes a video mean opinion score.

12. The method of claim 1, wherein the quality of experience metric includes stall information associated with the occurrence of stalls during playback of the video stream.

13. The method of claim 1, further comprising producing status information indicating a statistical confidence of the quality of experience metric.

14. The method of claim 1, wherein the packet information is derived using a network tap that is disposed on a communication link between the terminal node and the video server.

15. A network device, comprising:
a network interface for receiving packets associated with a video stream, the packets being transmitted from a video server to a terminal node, at least some of the packets being encrypted;
a memory configured to store executable instructions; and
a processor coupled to the network interface and the memory and configured to derive packet information from the packets, the packet information
including identification information and packet statistics, extract video stream features based on the packet information, estimate an occupancy level of a video playback buffer associated with the
video stream in the terminal node using the video stream features, and generate a quality of experience metric based at least in part on the
estimated occupancy level of the video playback buffer in the terminal node.

16. The network device of claim 15, wherein the processor is further configured to utilize machine learning to estimate the occupancy level of the video playback buffer.

17. The network device of claim 15, wherein the video stream is conveyed to the terminal node in one or more video transactions, each video transaction including transmission of a request from the terminal node and then transmission of one or more of the packets to the terminal node, wherein the video stream features include transaction features associated with the one or more video transactions.

18. The network device of claim 17, wherein the transaction features of the one or more video transactions include temporal features.

19. The network device of claim 15, wherein the video stream features are extracted for a sample period.

20. A non-transitory computer readable medium storing instructions that when executed perform steps for determining a quality of experience metric associated with a video stream being played at a terminal node, the steps comprising:
deriving packet information from packets associated with a video stream, the packets being transmitted from a video server to a terminal node, at least some of the packets being encrypted, the packet information including identification information and packet statistics;
extracting video stream features based on the packet information;
estimating an occupancy level of a video playback buffer associated with the video stream in the terminal node using the video stream features; and
generating the quality of experience metric based at least in part on the estimated occupancy level of the video playback buffer in the terminal node.
